(19) United States
(12) Patent Application Publication
(10) Pub. No.: US 2009/0158408 A1
(43) Pub. Date: Jun. 18, 2009

(54) METHODS, SYSTEMS, AND COMPUTER PRODUCTS FOR PROVIDING AND ACCESSING MEDIA

(75) Inventors: Jeffrey Cassanova, Villa Rica, GA (US); N. Peter Hill, Atlanta, GA (US)

Correspondence Address: AT&T Legal Department - CC;Attn: Patent Docketing, Room 2A-207, One AT&T Way, Bedminster, NJ, 07921, US

(73) Assignee: AT&T DELAWARE INTELLECTUAL PROPERTY, INC, Wilmington, DE (US)

(21) Appl. No.: 11/959,026

(22) Filed: Dec. 18, 2007

(51) Int. Cl. G06F 21/20

(52) U.S. Cl. 726/6

(57) ABSTRACT

Methods, systems, and computer products for providing media over an Internet Protocol (IP) based network. The methods, systems, and computer products include receiving a handle and/or password input by a user, associating the handle and/or password to a channel inaccessible by the public, mapping the handle and/or password input by the user to the inaccessible channel, and providing the inaccessible channel to the user.

### BACKGROUND

The present invention relates to Internet Protocol based television services, and more particularly to providing and accessing channels over an Internet Protocol based television network.

Current television (TV) cable and satellite systems are limited to a few hundred channels. Further, the primary user interface that is typically used for channel surfing is a hand-held TV remote control having twenty (20) to thirty (30) push buttons. More recently, TV-centric digital media center (DMC) systems have been provided and include a wireless keyboard similar to a personal computer (PC) keyboard that allows TV viewers to surf channels and control the DMC.

In an Internet-enabled broadband content access paradigm, such as an Internet Protocol based TV (IPTV) service, there may be hundreds of thousands or even millions of video content titles available over an IPTV service provider broadband network. Consequently, consumers today are faced with a constantly increasing number of choices when deciding what they will watch on TV.

Therefore, methods, systems and computer products are needed for providing and/or accessing media over an IPTV network.

### BRIEF SUMMARY

Exemplary embodiments include a method of providing media over an Internet Protocol (IP) based network. The method includes receiving a handle and/or password, associating the handle and/or password to a channel inaccessible to the public, mapping the handle and/or password to the inaccessible channel, and providing the inaccessible channel.

Additional exemplary embodiments include a system for accessing media over an Internet Protocol (IP) based network. The system includes a communication device operatively connected to an input device for receiving a handle and/or a password. The communication device is configured to operate on the IP based network and configured to transmit the handle and/or password. The communication device transmits the handle and/or password to an association database, and the association database is configured to associate the handle and/or password to a channel inaccessible by the public. The communication device accesses the inaccessible channel by having a mapping device map the handle and/or password to the inaccessible channel.

Further exemplary embodiments include a computer program product, tangibly embodied on a computer readable medium, for allowing access to media over an Internet protocol based network, where the computer program product has instructions for causing a computer to execute a method. The method includes receiving a handle and/or password input, associating the handle and/or password to a channel inaccessible to the public, mapping the handle and/or password to the inaccessible channel, and providing the inaccessible channel.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 illustrates a block diagram of exemplary embodiments of an IPTV system for accessing and providing media/channels;

FIG. 2 illustrates a flow chart of exemplary embodiments of accessing and/or providing media/channels on an IPTV system;

FIG. 3 illustrates a block diagram of exemplary embodiments of accessing and/or providing “Hidden Channels” for an IPTV service;

FIG. 4 illustrates a block diagram of inputting information in accordance with exemplary embodiments; and

FIG. 5 illustrates a flow chart of exemplary embodiments of mapping media over an IPTV network.

The detailed description explains the exemplary embodiments, together with advantages and features, by way of example with reference to the drawings.

### DETAILED DESCRIPTION OF EXEMPLARY EMBODIMENTS

With the advent of IPTV services over a broadband network, numerous channels or selections are available to the public. Exemplary embodiments of the present disclosure describe accessing and providing channels and/or media over an IPTV network where the channels and/or media may be unknown to and/or inaccessible by the public.

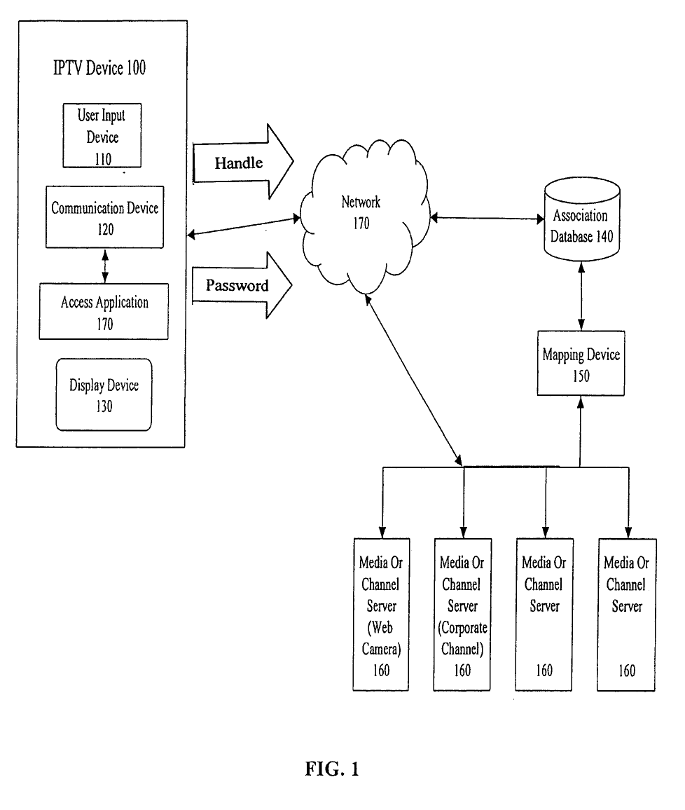

FIG. 1 illustrates a block diagram of an exemplary embodiment of an IPTV system for accessing and providing media/channels. FIG. 1 illustrates an IPTV device 100 comprising a user input device 110 (e.g., a remote control, a keyboard, a keypad, or a voice activated input device), a communication device (e.g., a set top box) 120 for transmitting/receiving communications over a network 170, and a display device 130. By means of the user input device 110, the user may select a program listing of available channels (e.g., a menu guide) displayed on the display device 130. However, the program listing may not show the media/channel (e.g., a hidden channel) that the user desires to access (i.e., watch). In accordance with exemplary embodiments, the hidden channel is unpublished, and access to the hidden channel is restricted access, such that the program listing would not list the hidden channel. According to exemplary embodiments, an access application 170 is enabled/launched and provides an interface such that the user may enter a handle and/or password via user device 110 on an access application screen displayed of the display device 130. As a non-limiting example, the access application 170 is stored in the communication device 120, such as a set top box, or the access application 170 is stored and provided by the IPTV service provider. The communication device 120 transmits the handle and/or password to an association database 140 via network 170, according to exemplary embodiments. The association database 140 is configured to identify the handle and/or password and to associate the handle and/or password to the corresponding media/channel (e.g., a hidden channel).

A mapping device 150 uses the association made between the handle and the corresponding media/channel (e.g., a hidden channel) identified in the association database 140. The mapping device 150 maps the handle input by the user via the input device 110, to media/channels on media/channel servers 160, according to exemplary embodiments. The media/channel is provided to the user via the communication device 120 of the IPTV device 100. In accordance with exemplary embodiments, the mapping device 150 designates an access path from the communication device 120 via the network 170 to the media/channel (e.g., a hidden channel) on the media/channel servers 160. In accordance with exemplary embodiments, the mapping device 150 establishes a connection with the media/channel server 160 (e.g., hidden channel). The communication device 120 may be, as a non-limiting example, a set top box that is capable of operating on the network 170 (e.g., an IPTV network), and the set top box may be configured to perform the functions of the mapping device 150. In non-limiting examples, the mapping device 150 may be a server, and the server may have an application for performing the functions of the mapping device 150.

The network 170 may include circuit-switched and/or packet-switched technologies and devices, such as routers, switches, hubs, gateways (e.g., residential gateways, including a DSL modem, etc.) etc. The network 170 may include wireline and/or wireless components utilizing, e.g., 802.11 standards for providing over-the-air transmissions of communications. The network 170 can be an IP-based network and be a managed IP network administered by a service provider, which can control bandwidth and quality of service for the communications over the network 170. The network 170 may be implemented in a wireless fashion, e.g., using wireless protocols and technologies, such as WiFi, WiMax, etc. The network 170 can also be a packet-switched network as a local area network, wide area network, metropolitan area network, Internet network, or other similar type of network environment. The network 170 may be a cellular communications network, a fixed wireless network, a wireless local area network (LAN), a wireless wide area network (WAN) a personal area network (PAN), a virtual private network (VPN), intranet or other suitable network system and includes equipment for receiving and transmitting signals such as a cell tower and mobile switching center. In another exemplary embodiment, the network 170 can be a circuit-switched network such as a standard public switched telephone network (PSTN).

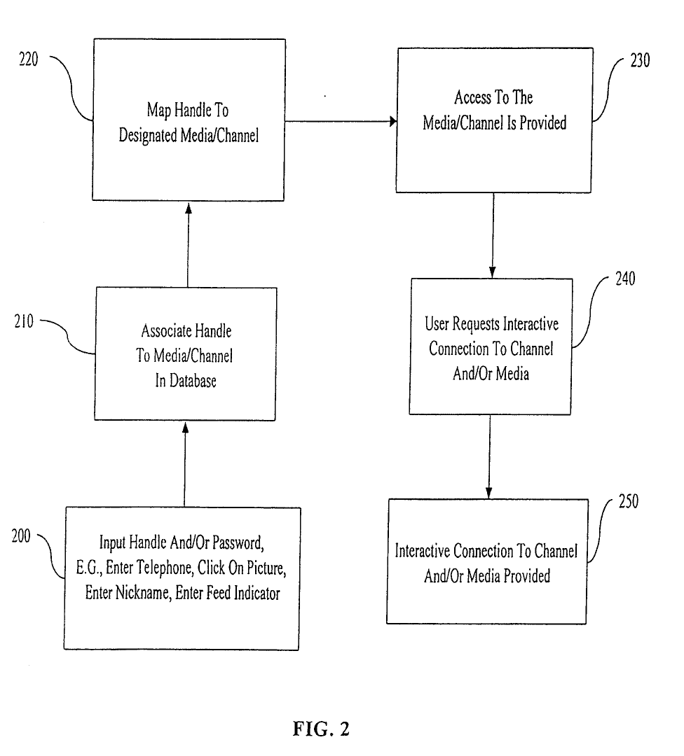

FIG. 2 illustrates a flow chart of an exemplary embodiment of accessing and providing media/channels on an IPTV system. A user may input known information via an input device at 200. In a non-limiting example, the user may input a “handle” which may be an informal name that is associated with a “Hidden Channel”. As other non-limiting examples, the user may input a telephone number, click on a picture, enter a nickname, or some other type of feed indicator. In most cases, the user knows the handle in advance.

In accordance with exemplary embodiments, the “Hidden Channel” may be a channel inaccessible to the public, and the “Hidden Channel” may be undisclosed and unknown to the public. More about the “Hidden Channel” is discussed herein.

The handle is associated with corresponding media/channel in a database(s), or in a server or storage medium by an IPTV network provider or a media content provider at 210.

In accordance with exemplary embodiments, there may be various handles, such as names, designations, or other identifiers, associated with the same media/channel, and the handles are identified and authenticated in the database or server to be sure that they correspond to the media/channel. As non-limiting examples, the access application 170 may be used to identify and authenticate the handle. As non-limiting examples, the association database 140 (or a server) may identify and authenticate the handle. As discussed herein, the user may also input a password concurrently with or subsequent to the handle, and the password is identified and authenticated.

The handle is mapped to the designated media/channel (or vice versa) over the IPTV network at 220. As a non-limiting example, a set top box (e.g., the communication device 120) may be used to map to the designated hidden channel/media. Conversely, as another non-limiting example, the IPTV service provider maps to the hidden channel/media. The user may access (or tune to) the media/channel at 230. As non-limiting examples, the user may access web cameras, files, CDs, music files, IP addresses, URLs, etc.

In accordance with exemplary embodiments, the user may request an interactive connection to the channel/media at 240. An interactive connection to the channel/media is provided (established) at 250. Although FIG. 2 illustrates a request for an interactive connection occurring in operation 240, a request for an interactive connection may concurrently occur and be recognized in operations 200, 210, and 230. In accordance with exemplary embodiments, the interactive request/connection may cause the user's telephone to ring, such that the user can talk to the content provider of the channel/media. For example, the user may interact in a panel discussion. In accordance with exemplary embodiments, the interactive connection may cause a user's web camera and/or microphone to become active (live), such that the user may be heard and/or viewed by the channel/media provider or by others accessing the channel/media. The user may interact by transmitting files, documents, media (video and audio content), etc., over the IPTV interactive connection.

Further, in accordance with exemplary embodiments, an individual may desire to have his/her own channel for others to access, and the channel may be published or unpublished. In other words, the individual may choose to allow restricted or unrestricted access to his channel. The individual may sign-up with the IPTV network provider (i.e., service provider). The individual may have information (i.e., handles) that he desires to be associated with his channel/media, which may be, as non-limiting examples, a telephone number, a nickname, or other identifier. The individual associates the handle (e.g., user ID, information) to his channel and/or media, such that others can have restricted or unrestricted access to the media/channel over an IPTV network (in operation 210). On the other hand, the IPTV network provider (i.e., service provider) may associate the handle to the channel/media for the individual (in operation 210). Also, some of the information (handles) may be associated by the individual and some by the IPTV network provider (in operation 210). Although, the individual may have a single channel, the same channel may be accessed using multiple handles (e.g., a telephone number, nickname, or other identifier). In accordance with exemplary embodiments, there may be meta data associated with the content of the channel/media. The meta data can be provided by the IPTV network provider or by the individual creating the channel/media.

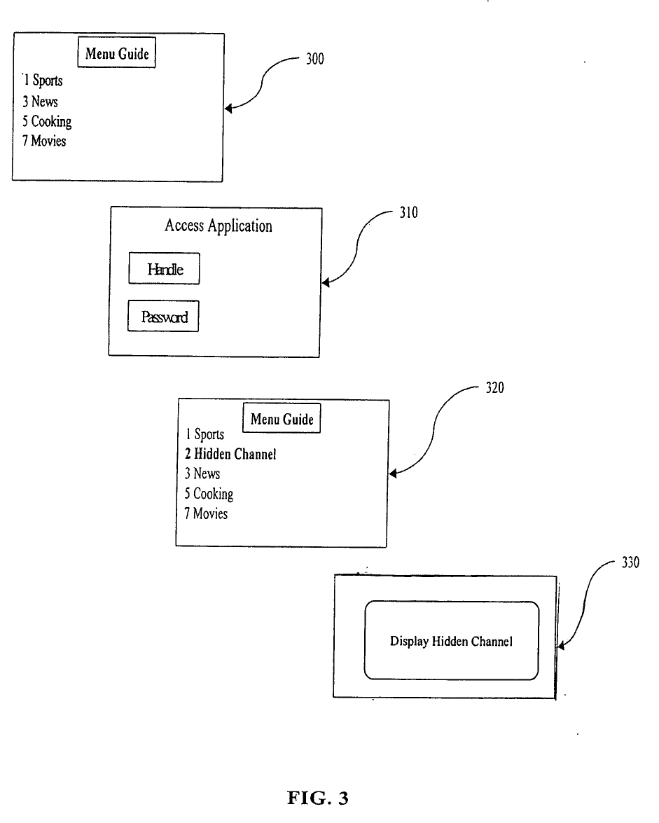

FIG. 3 illustrates a block diagram of an exemplary embodiment of accessing/providing “Hidden Channels” for an IPTV service. As a non-limiting example, FIG. 3 depicts a series of screens 300-330. Exemplary embodiments are not limited to a particular number of screens, a certain visual arrangement and/or representation on the screens, nor a particular on-screen nomenclature.

A user desiring to access a hidden channel may view a screen 300 with a menu guide. The menu guide includes a listing of various channels (e.g., sports, news, cooking, movies, etc.) on the screen 300. However, the user may want to access a hidden channel not available on the menu guide shown on the screen 300. The user views the screen 310, supported by an access application in which a handle and/or password may be input to access the hidden channel. The handle and/or password are properly identified/authenticated. The handle is associated with and mapped to the corresponding media/channel. In accordance with exemplary embodiments, the user may only input a handle without a password to access the hidden channel, or the user may input a handle concurrently with a password. In accordance with another exemplary embodiment, the user may enter a handle on one screen, and another screen may appear in which the user enters a password. Further, in accordance with exemplary embodiments, the access application may be launched from a server provided by the IPTV service provider and/or the communication device 120, such as a set top box.

In FIG. 3, the screen 320 depicts a menu guide having a listing of channels, and the hidden channel is now made available to the user as one of the listed channels. In accordance with exemplary embodiments, the IPTV service provider (or a set top box) maps to the hidden channel and makes the hidden channel available to the user. The user selects the hidden channel, and the contents of the hidden channel are displayed on the screen 330. The use of a menu guide (e.g., a user guide) in FIG. 3 is not meant to be limiting, and any channel, subject, and/or title listing may be used to identify available media/channels. Moreover, one skilled in the art understands that the exemplary embodiment illustrated in FIG. 3 may employ different forms and visual layouts and understands that the exemplary embodiment is not meant to be limiting.

In accordance with exemplary embodiments, the hidden channel is unpublished and unknown to the user in advance. The hidden channel may comprise access to a restricted channel (private information), a corporate channel that is available to employees, a web camera, a church channel, audio/video content, etc. In a non-limiting example, the hidden channel may be restricted information that is inaccessible by (or even unknown to) the public.

In accordance with exemplary embodiments, the user knows the handle and/or password in advance such that the user may access the media/channel and/or hidden channel over the IPTV network. In accordance with exemplary embodiments, the hidden channel is unsearchable.

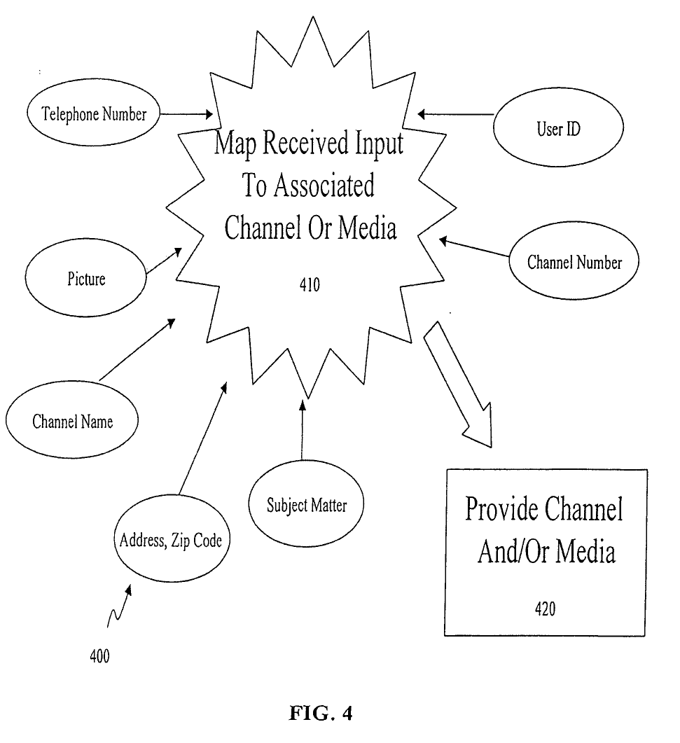

FIG. 4 is a block diagram illustrating inputting information in accordance with an exemplary embodiment. When the handle 400 is input at operation 200 in FIG. 2, various information may be used. Handles 400 may include various information, such as telephone numbers, pictures, handles, user ID, etc., that is associated with media/channel. The handle 400 is mapped 410 to the media/channel associated with the handle 400. In accordance with exemplary embodiments, the handle may be mapped to the media/channel by the communication device 120 (e.g., a set top box). In accordance with exemplary embodiments, the handle may be mapped to the media/channel by the mapping device 150 (e.g., a server). In accordance with exemplary embodiments, mapping the handle comprises designating an access path from the communication device 120 of a user to the media/channel that corresponds to the handle 400. The media/channel 420 is provided to the user via the communication device 120. In accordance with exemplary embodiments, FIG. 4 depicts non-limiting examples of handles 400 that may be used.

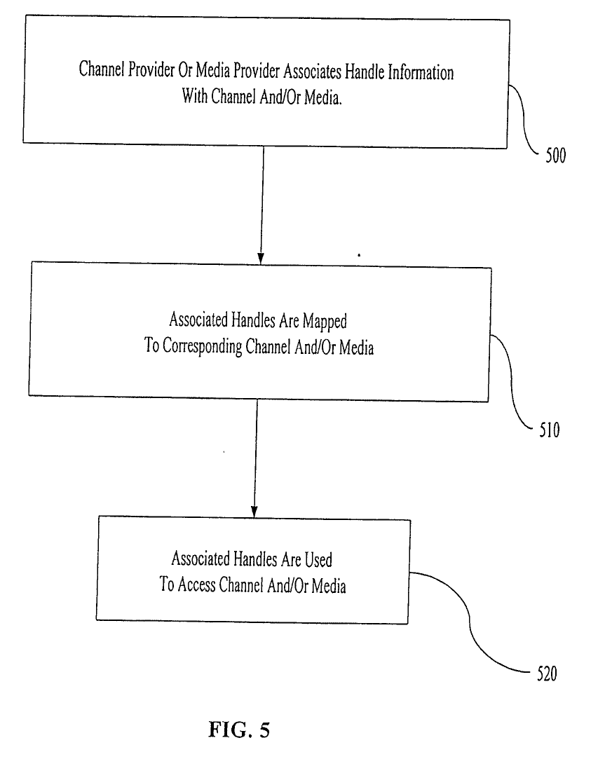

FIG. 5 illustrates an exemplary embodiment of providing media over an IPTV network. A channel provider or media provider associates a handle (various information) to a channel or media at 500. The associated information is mapped to the corresponding channel or media at 510. The associated information is used to access the channel or media at 520. Also, the associated information (e.g., a handle) may be used to list channels and/or media as illustrated in FIG. 3.

The terms channel and media are used throughout and the use of one term is not meant to exclude the other term. As non-limiting examples, channel and media may be synonymous or slightly different. Also, the term channel is not limited to a single channel and may represent numerous channels each having different content. Further, in non-limiting examples, the term media may represent the type of content accessed via the channel, and the media may be different on various channels. As such, a user may access a channel via a handle to view the media presented on the channel in a non-limiting example. The terms channel and media may also encompass their ordinary meanings and are not meant to be limited.

As described above, exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the present disclosure has been described with reference to exemplary embodiments, it will be understood by those skilled in the art that various changes may be made and equivalents may be substituted for elements thereof without departing from the scope. In addition, many modifications may be made to adapt a particular situation or material to the teachings of the present disclosure without departing from the essential scope thereof. Therefore, it is intended that the present disclosure not be limited to the particular exemplary embodiments disclosed, but that the present disclosure will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of providing media over an Internet Protocol (IP) based network, comprising:
receiving at least one of a handle and password;
associating the at least one of the handle and password to a channel inaccessible to the public;
mapping the at least one of the handle and password to the inaccessible channel; and
providing the inaccessible channel.

2. The method of claim 1, wherein associating the at least one of the handle and password to the inaccessible channel comprises identifying the at least one of the handle and password in a database, and corresponding the at least one of the handle and password to the inaccessible channel.

3. The method of claim 1, wherein mapping the at least one of the handle and password to the inaccessible channel comprises at least one of:
designating an access path from a communication device of a user to the inaccessible channel that corresponds to the at least one of the handle and password, and
establishing a connection with the inaccessible channel.

4. The method of claim 1, further comprising:
providing a first listing of available channels to a user, wherein the first listing of available channels excludes the inaccessible channel; and
providing a second listing of available channels to a user in response to the at least one of the handle and password being received, wherein the second listing of available channels comprises the inaccessible channel such that the user may select and access the inaccessible channel.

5. The method of claim 1, further comprising displaying an interface, being supported by an access application, in which the at least one of the handle and password are input by a user.

6. The method of claim 1, further comprising:
receiving a request from a user for an interactive connection to the inaccessible channel; and
providing to the user the interactive connection to the inaccessible channel.

7. The method of claim 6, wherein the interactive connection to the inaccessible channel allows a user to be at least one of viewed and heard by at least one of a content provider of the inaccessible channel and another user accessing the inaccessible channel.

8. A system for accessing media over an Internet Protocol (IP) based network, comprising:
a communication device, the communication device being operatively connected to an input device for receiving at least one of a handle and a password,
the communication device is configured to operate on the IP based network and configured to transmit at least one of the handle and password;
the communication device transmits the at least one of the handle and password to an association database, the association database being configured to associate at least one of the handle and password to a channel inaccessible by the public; and
the communication device accesses the inaccessible channel by having a mapping device map at least one the handle and password to the inaccessible channel.

9. The system of claim 8, further comprising a display device for displaying the content of the inaccessible channel.

10. The system of claim 8, wherein the at least one of handle and password is known in advance by a user.

11. The system of claim 8, wherein at least one of the inaccessible channel and handle is unsearchable over the IP based network.

12. The system of claim 8, further comprising:
a first listing of available channels displayed on a display device, wherein the first listing excludes the inaccessible channel; and
a second listing of available channels displayed on the display device, wherein, in response to the at least one of the handle and password being input, the second listing comprises the inaccessible channel such that a user may access the inaccessible channel.

13. The system of claim 12, wherein the first and second listings of available channels are menu guides.

14. The system of claim 8, wherein the communication device is a set top box configured to operate on an IP based network.

15. The system of claim 8, further comprising an access application displayed on a display device, the access application being an interface in which the at least one of the handle and password are input, wherein the access application is configured to permit or deny access to the inaccessible channel.

16. A computer program product, tangibly embodied on a computer readable medium, for allowing access to media over an Internet protocol based network, the computer program product including instructions for causing a computer to execute a method, comprising:
receiving at least one of a handle and password input;
associating the at least one of the handle and password to a channel inaccessible to the public;
mapping the at least one of the handle and password to the inaccessible channel; and
providing the inaccessible channel.

17. The computer program product of claim 16, wherein associating the at least one of the handle and password to the inaccessible channel comprises identifying the at least one of the handle and password in a database, and corresponding the handle to the inaccessible channel.

18. The computer program product of claim 16, wherein mapping the at least one of the handle and password to the inaccessible channel comprises at least one of:
designating an access path from a communication device to the inaccessible channel that corresponds to the at least one of the handle and password, and
establishing a connection with the inaccessible channel.

19. The computer program product of claim 16, further comprising:
providing a listing of channels with no inaccessible channel available; and
providing another listing of channels with the inaccessible channel available in response to receiving the at least one of the handle and the password input by a user, such that the user is allowed to select and access the inaccessible channel.

20. The computer program product of claim 16, further comprising:
receiving a request from a user for an interactive connection to the inaccessible channel; and
providing to the user the interactive connection to the inaccessible channel, wherein the interactive connection to the inaccessible channel allows the user to be at least one of viewed and heard by at least one of a content provider of the inaccessible channel and another user accessing the inaccessible channel.
